(19) United States
(12) Patent Application Publication
(10) Pub. No.: US 2016/0328701 A1
(43) Pub. Date: Nov. 10, 2016

(54) MOBILE POINT OF SALE SYSTEM FOR REVERSE SETTLEMENT, AND METHOD THEREOF

(71) Applicant: Dohoon LEE, Kwangyang City, Jeollanam-do (KR)

(72) Inventor: Dohoon LEE, Kwangyang City, Jeollanam-do (KR)

(21) Appl. No.: 15/109,276

(22) PCT Filed: Dec. 30, 2014
(86) PCT No.: PCT/KR2014/013091

§ 371 Date: Jun. 30, 2016

(30) Foreign Application Priority Data
Dec. 31, 2013 (KR) 10-2013-0168041

(51) Int. Cl. G06Q 20/32; G06K 19/06; G06Q 20/20; G06K 7/14

(52) U.S. Cl. CPC G06Q 20/3276; G06K 7/1413; G06K 19/06028; G06K 19/06112; G06Q 20/20

(57) ABSTRACT

The present invention relates to techniques for conducting transactions, and more particularly to techniques for point of sale transactions wherein, a purchaser settles bill to connect his/her own mobile terminal to transaction server using tranction information displayed on the merchant mobile screen in barcode form. The point of sale system for the merchant is composed of a plurality of slave merchant mobiles to dislplay tranction information from a master merchant mobile to perchasers, and each slave merchant mobile is centalized to the master merchant mobile. The present POS system enables purchaser's information not to be offered to the merchant side, to execute settlement process at the purchaser mobile using transaction information from the merchant only. And for the merchant mobile side, the mobile displays barcoded transaction information and receives settlement result, which makes the trade transaction simple. Furthermore, a merchant mobile commands a mass of transactions for many purchaser mobiles engaging a plurality of slave merchant mobiles.

### TECHNICAL FIELD

The present disclosure relates to techniques for conducting transactions, and more particularly to techniques for point of sale transactions wherein, a purchaser settles bill to connect his/her own mobile terminal to transaction server using tranction information displayed on the merchant mobile screen in barcode form. The point of sale system for the merchant is composed of a plurality of slave merchant mobiles to dislplay tranction information from a master merchant mobile to perchasers, and each slave merchant mobile is centalized to the master merchant mobile.

### BACKGROUND ART

Point of sale systems comprising mobile terminals to settle the bill for perchased goods or services are introduced in prior arts.

FIG. 1 shows an example embodiment of POS device enabling purchasers to pay bill using mobiles, disclosed in Korean granted patent 10-0822160 B1. The embodiment directs to a system for providing a mobile shopping service to enable a sale company equipped with a wide branch network to offer AD (ADvertisement) and services suitable for feature of each branch to a mobile terminal, and integrally use integrally managed royalty information when a customer pays an article or service price through the mobile terminal. The mobile terminal includes an IC chip storing credit card information of the customer and an application program. A POS (Point Of Sale) system receives the credit card information from the mobile terminal, transmits a royalty information request including a credit card number to a mobile shopping service server, and processes payment of the customer by using the royalty information received from the mobile shopping service server. The mobile shopping service server processes a service by receiving a mobile shopping service request, collects/transmits the royalty information to the POS system by using the credit card number. A payment server processes the payment based on the credit card information received from the POS system.

FIG. 2 is another embodiment of mobile credit card transaction technique disclosed in Korean granted patent 10-1212243 B1. In the embodiment, a mobile credit card payment system and method thereof are provided to prevent the exposure of credit card number information by directly requesting approval for purchasing products to a credit card company. A card subscriber terminal apparatus(10) includes a wireless terminal(12) for access the Internet and a payment apparatus. A marketing server(30) manages and registers product information by authenticating users. The marketing server transmits payment approval information to a card member store terminal apparatus(20). A credit card company server transmits the payment approval information to the card subscriber terminal apparatus and the marketing server.

FIG. 3 illustrates brief structure of the other background art from Korean granted patent 10-0773918 B1, ‘a method and a system for billing/paying a charge using a settlement function of a mobile wallet’, to enable a user to determine payment in a budget range of the user with a settlement service function of an electronic wallet mounted to a mobile device by fixing priority without exposing financial information to the billing company. The mobile device(10) performs mobile settlement for the charge by including the electronic wallet storing the financial information such as account and credit card information. A billing company system(30) sends a bill or a notification for the charges to a customer, and receives the charge by receiving a payment result after sending a charge guide message to the mobile device of the customer registering the mobile settlement. A mobile communication center(20) sends an SMS (Short Message Service) to the mobile device of the customer according to a notification request of the billing company, requests transfer or credit card settlement to a financial institution(40) according to a mobile settlement will of the customer, and informs the mobile device and the billing company of a result.

### DISCLOSURE OF INVENTION

### Technical Problem

In most of conventional mobile point of sale settlement process, a purchaser have to swipe credit card into the merchant's terminal or to transmit credit card information to the merchant to settle the bill. Through these processes, personal information of the purchaser can be exposed and abused by the others. Furthermore, conventional mobile point of sale systems are still for less frequent trades, not comprise functions proper for a mass of transactions at a time (ie. at marts or stadiums with many perchasers). These limitations result boundaries of conventional mobile point of sale settlement technique, only to be used for small scale trades.

### Solution to Problem

Present invention offers a mobile point of sale system for reverse settlement wherein;

the purchaser mobile comprising; the first controller to control over purchaser mobile; the first mobile communication unit to connect purchaser mobile to transaction server via mobile communication network; creditcard information storage to store creditcard information of purchaser for settlement; the first short range communication unit to establish communication between the purchaser mobile and merchant mobile; transaction information storage to store transaction information from the merchant mobile; barcode decoder to read barcoded transaction information from the merchant mobile screen by a camera.

and the merchant mobile comprising; the second controller to control over merchant mobile; the second mobile communication unit to connect merchant mobile(200) to mobile communication network; display unit to display barcoded transaction information of merchant mobile; billing information calculation and store unit to calculate and store billing amount, and to generate barcodes of transaction information; the second short range communication unit to establish short range communication with purchaser mobile and other merchant mobiles (slave merchant mobiles); mobile data storage to mobile IDs (or IP addresses) of other merchant mobiles;

and operating methods for the system as technical solution.

### Advantageous Effects of Invention

The mobile point of sale system and method of present invention offer advantageous technical effects compared to conventional mobile transaction systems.

The present POS system enables purchaser's information not to be offered to the merchant side, to execute settlement process at the purchaser mobile using transaction information from the merchant only. And for the merchant mobile side, the mobile displays barcoded transaction information and receives settlement result, which makes the trade transaction simple. Furthermore, a merchant mobile commands a mass of transactions for many purchaser mobiles engaging a plurality of slave merchant mobiles.

### BRIEF DESCRIPTION OF DRAWINGS

FIG. 1 shows an example embodiment of POS device enabling purchasers to pay bill using mobiles, as a prior art

FIG. 2 is another embodiment of mobile credit card transaction technique, as a prior art

FIG. 3 illustrates brief structure of the other background art.

FIG. 4 shows an examplar scheme of conventional mobile transaction structure

FIG. 5 shows connection scheme of purchaser mobile, merchant mobile, and transaction server of embodiment of the invention

FIG. 6 shows settlement process sequence for an embodiment of the invention

FIG. 7 shows another settlement process sequence for an embodiment of the invention

FIG. 8 illustrates structure of purchaser mobile of the present invention

FIG. 9 shows structure of merchant mobile corresponding to the purchaser mobile of the present invention

FIG. 10 shows process flow of embodiment of present invention

FIG. 11 shows process flow of another embodiment of present invention

FIG. 12 depicts another embodiment of POS system of the invention, wherein a plurality of slave merchant mobiles are engaged.

FIG. 13 shows process flow of the embodiment of present invention for a mass of transaction

FIG. 14 shows process flow of another embodiment of present invention for a mass of transaction

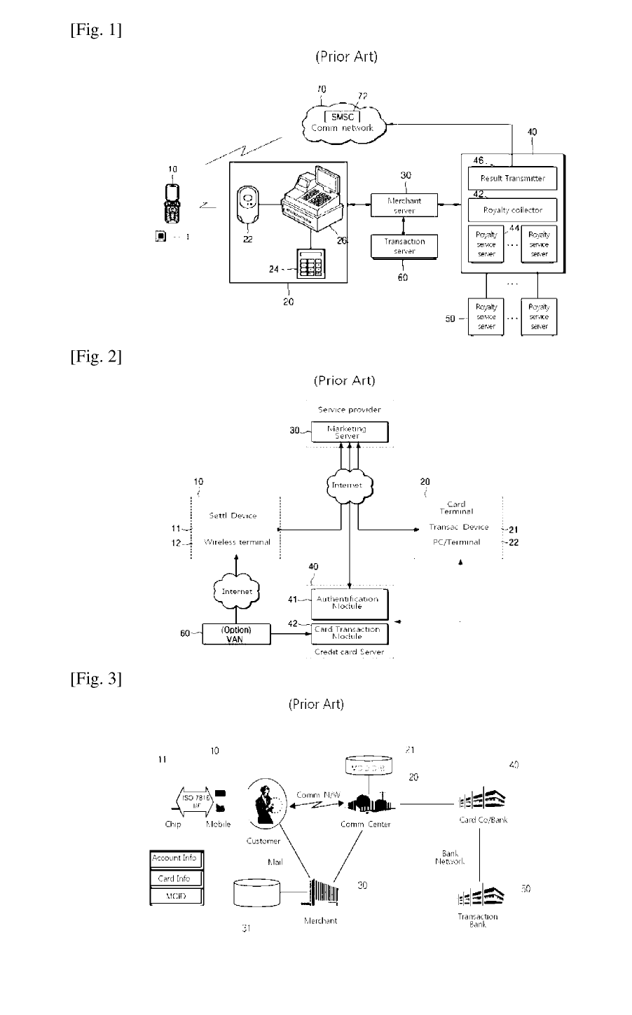

### BEST MODE FOR CARRYING OUT THE INVENTION

As the best mode for invention, present invention offers a mobile point of sale system and methods for reverse settlement using;

purchaser mobile comprising; the first controller to control over purchaser mobile; the first mobile communication unit to connect purchaser mobile to transaction server via mobile communication network; creditcard information storage to store creditcard information of purchaser for settlement; the first short range communication unit to establish communication between the purchaser mobile(100) and merchant mobile; transaction information storage to store transaction information from the merchant mobile; barcode decoder to read barcoded transaction information from the merchant mobile screen by a camera.

and the merchant mobile comprising; the second controller to control over merchant mobile; the second mobile communication unit to connect merchant mobile(200) to mobile communication network; display unit to display barcoded transaction information of merchant mobile; billing information calculation and store unit to calculate and store billing amount, and to generate barcodes of transaction information; the second short range communication unit to establish short range communication with purchaser mobile and other merchant mobiles (slave merchant mobiles); mobile data storage to mobile IDs (or IP addresses) of other merchant mobiles.

### MODE FOR THE INVENTION

Reference will now be made in detail to various embodiments of the invention. Examples of these embodiments are illustrated in the accompanying drawings. While the invention will be described in conjunction with these embodiments, it will be understood that it is not intended to limit the invention to any embodiment. On the contrary, it is intended to cover alternatives, modifications, and equivalents as may be included within the spirit and scope of the invention as defined by the appended claims. In the following description, numerous specific details are set forth in order to provide a thorough understanding of the various embodiments. However, the present invention may be practiced without some or all of these specific details. In other instances, well known process operations have not been described in detail in order to not unnecessarily obscure the present invention. Further, each appearance of the phrase “example embodiment” or “illustrative embodiment” at various places in the specification does not necessarily refer to the same example or illustrative embodiment.

Example embodiments allow a transaction over the Internet to have the same look and feel as a wireless transaction conducted in person at a POS terminal at a store. In some embodiments, the consumer utilizes the same PIN that has been stored in the portable device for use in the wireless transaction at the store for transactions over the Internet. The example embodiments do not require a separate authentication process to authenticate the cardholder and do not require the cardholder to remember a password different from the PIN or to enter an additional password during a transaction.

Hereinafter, the present invention will be described in detail by explaining exemplary embodiments of the invention with reference to the attached drawings. Detailed explanation will not be given when it is determined that detailed explanation about wellknown function and configuration of the present invention may dilute the point of the present invention. The present invention will now be described more fully with reference to the accompanying drawings, in which exemplary embodiments of the invention are shown.

FIG. 4 shows an examplar scheme of conventional mobile transaction structure. In the transaction process, a merchant notices billing data to a purchaser or data for settlement is offered to the purchaser mobile. Then the purchaser swipes his/her credit card or transmits credit card data stored in the mobile to the merchant. The merchant sends purchaser's credit card data with billing data to transaction server to request settlement, the transaction server executes transaction and settlement is finished by sending approval data back to the merchant. Conventional mobile transaction technologies are adopted in many businesses however, the purchaser is still not protected from other's misuse of personal information like identity theft since the purchaser have to handover his/her own information to the merchant side for settlement.

FIG. 5 shows connection scheme of purchaser mobile(100), merchant mobile(200), and transaction server(300) of embodiment of the invention. For the present mobile point of sale system, purchaser mobile(100) and merchant mobile(200) are connected through mobile communication network. An example of such mobile communication network may be 3GPP LTE network comprising Radio Network Subsystem (RNS) and HeNS (Home eNode Subsystem) with small cell, which connect purchaser mobile(100) and merchant mobile(200) to EPC (Evolved Packet Core) Network to service PSTN and internet services. In the present mobile point of sale system, transaction server(300) may be accessed through internet via EPC Network, and for the modified embodiment, the transaction server(300) also can be prepared to be connected to purchaser mobile(100) and merchant mobile(200) via HeNS (Home eNode Subsystem) when the needed coverage of transactions are limited over the merchant space (ie. within the store). Furthermore, as long as EPC Network can offer Circuit Switching (CS) service, merchant mobile(200) can be connected via telephone line.

FIG. 6 shows settlement process sequence for an embodiment of the invention. The settlement is proceeded in sequence as numbered in the figure, and detailed process is as follows.

1. Merchant inputs to his/her mobile, billing amount for the goods or services offered to the purchaser. The merchant mobile generates transaction information including billing amount, ID (or internet protocol IP address) of merchant mobile, and additional data (ie. bank account for transaction etc.). Then the merchant mobile transforms the transaction information into a barcode, and displays on the screen.

2. Next, the purchaser mobile reads the barcoded information on the merchant mobile to extract the transaction information, and hashes the transaction information with purchaser's credit card information. The hashed information is sent to transaction server to request settlement.

3. On receiving the settlement request, the transaction server accesses settlement and sends result information back to the purchaser mobile.

4. As long as the purchaser mobile ID (or internet protocol IP address) of the merchant's mobile is informed, the purchaser mobile transmits settlement result information received from the transaction server to the merchant mobile(200) and the settlement is finished.

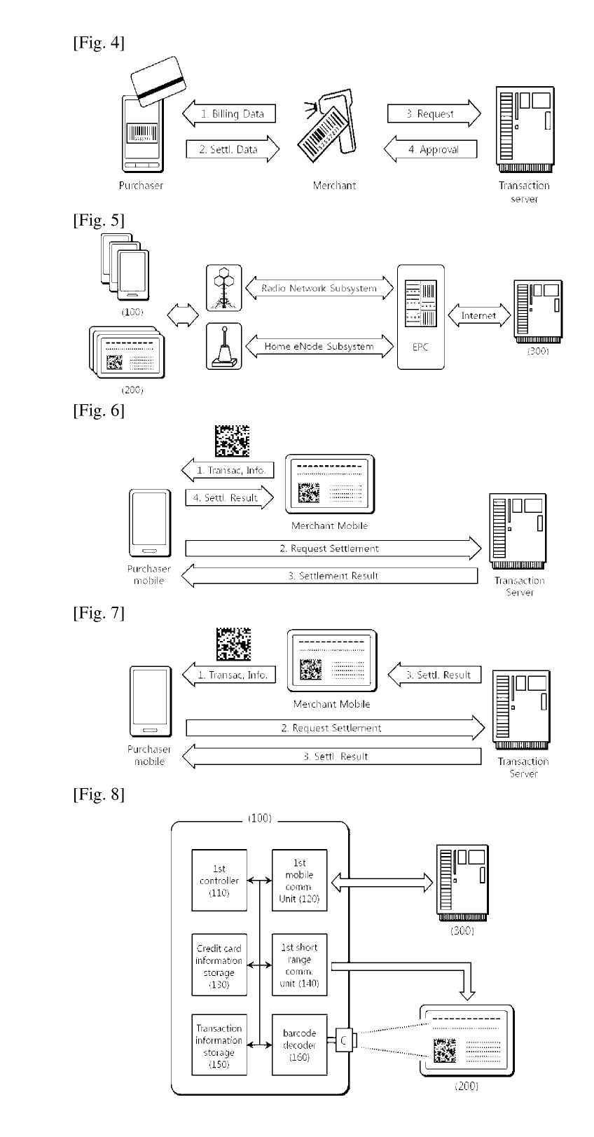

FIG. 7 shows another settlement process sequence for an embodiment of the invention. This settlement is different from the one described in the FIG. 6 in that the transaction server sends settlement result information back to both of the purchaser mobile and the merchant mobile. The detailed process is as follows.

1. Merchant inputs to his/her mobile, billing amount for the goods or services offered to the purchaser. The merchant mobile generates transaction information including billing amount, ID (or internet protocol IP address) of merchant mobile, and additional data (ie. bank account for transaction etc.). Then the merchant mobile transforms the transaction information into a barcode, and displays on the screen.

2. Next, the purchaser mobile reads the barcoded information on the merchant mobile to extract the transaction information, and hashes the transaction information with purchaser's credit card information. The hashed information is sent to transaction server to request settlement.

3. On receiving the settlement request, the transaction server accesses settlement and sends result information back to the purchaser mobile and the merchant mobile. Then the settlement is finished.

As seen from the description above, the present invention enables purchaser's information not to be offered to the merchant side, to execute settlement process at the purchaser mobile using transaction information from the merchant only. For the merchant mobile side, the mobile displays barcoded transaction information and receives settlement result, which makes the trade transaction simple.

FIG. 8 illustrates structure of purchaser mobile of the present invention. Purchaser mobile(100) of the present invention comprises;

the first controller(110) to control over purchaser mobile(100);

the first mobile communication unit(120) to connect purchaser mobile(100) to transaction server(300) via mobile communication network;

creditcard information storage(130) to store creditcard information of purchaser for settlement; (when purchaser mobile(100) uses mobile card reader device, the information read by the reader may be stored into the creditcard information storage(130) by the first controller(110))

the first short range communication unit(140) to establish communication between the purchaser mobile(100) and merchant mobile(200);

transaction information storage(150) to store transaction information from the merchant mobile(200);

barcode decoder(160) to read barcoded transaction information from the merchant mobile(200) screen by a camera (c).

The first short range communication unit(140) of purchaser mobile(100) may be adopted from conventional means (ie. IEEE 802.11 series, bluetooth, wifi etc.) to communicate with merchant mobile(200).

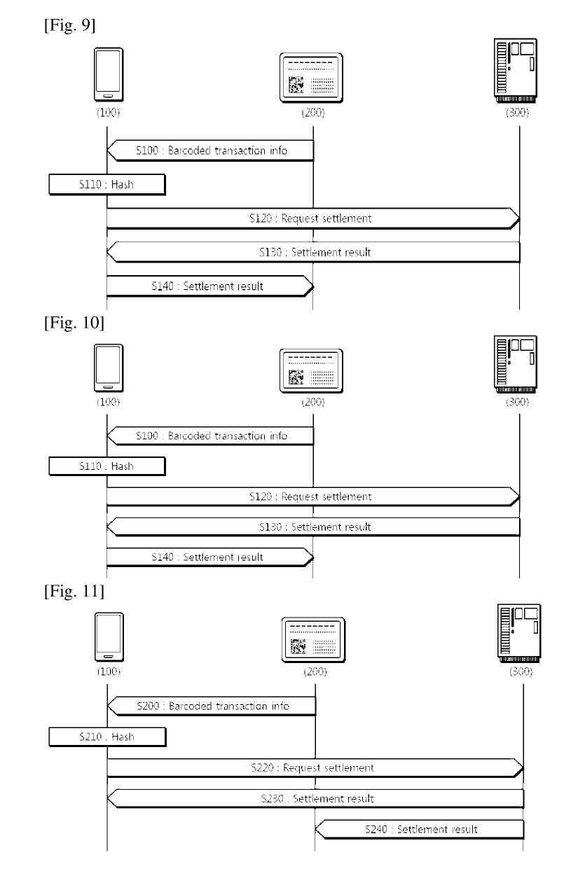

FIG. 9 shows structure of merchant mobile corresponding to the purchaser mobile(100) of the present invention. Merchant mobile(200) of the present invention comprises;

the second controller(210) to control over merchant mobile(200);

the second mobile communication unit(220) to connect merchant mobile(200) to mobile communication network;

display unit(230) to display barcoded transaction information of merchant mobile;

billing information calculation and store unit(240) to calculate and store billing amount, and to generate barcodes of transaction information;

the second short range communication unit(240) to establish short range communication with purchaser mobile(100) and other merchant mobiles(20X: ie. slave merchant mobiles);

mobile data storage(250) to mobile IDs (or IP addresses) of other merchant mobiles(20X);

Corresponding to the first short range communication unit(140) of purchaser mobile(100), the second short range communication unit(240) may be adopted from conventional short range communication means (ie. IEEE 802.11 series, bluetooth, wifi etc.).

The merchant mobile(200) also can be connected to other merchant mobiles(20X: ie. slave merchant mobiles) by the second mobile communication unit(220) via mobile communication network.

FIG. 10 shows process flow of embodiment of present invention. The detailed process is as follows.
Step S100: merchant inputs billing amount for the goods or services offered to the purchaser to his/her mobile, and merchant mobile(200) generates transaction information including billing amount, ID (or internet protocol IP address), with additional data (ie. bank account for transaction etc.), then the merchant mobile(200) transforms the transaction information into a barcode, and displays on the screen.
Step S110: the purchaser mobile(100) reads the barcode from the merchant mobile(200) to extract the transaction information, and hashes the transaction information with purchaser's credit card information, then stores into transaction information storage(150).
Step S120: the purchaser mobile(100) reads the hashed information out from the transaction information storage(150) and sends to transaction server(300) to request settlement.
Step S130: On receiving the settlement request, the transaction server(300) accesses settlement and sends result information back to the purchaser mobile(100).
Step S140: the purchaser mobile(100) transmits settlement result information received from the transaction server(300) to the merchant mobile(200) and the settlement is finished.

FIG. 11 shows process flow of another embodiment of present invention. This settlement is different from the one described referring the FIG. 10 in that the transaction server sends settlement result information back to both of the purchaser mobile and the merchant mobile. The detailed process is as follows.
Step S200: merchant inputs billing amount for the goods or services offered to the purchaser to his/her mobile, and merchant mobile(200) generates transaction information including billing amount, ID (or internet protocol IP address), with additional data (ie. bank account for transaction etc.), then the merchant mobile(200) transforms the transaction information into a barcode, and displays on the screen.
Step S210: the purchaser mobile(100) reads the barcode from the merchant mobile(200) to extract the transaction information, and hashes the transaction information with purchaser's credit card information, then stores into transaction information storage(150).
Step S220: the purchaser mobile(100) reads the hashed information out from the transaction information storage(150) and sends to transaction server(300) to request settlement.
Step S230, S240: On receiving the settlement request, the transaction server(300) accesses settlement and sends result information back to the both of purchaser mobile(100) and merchant mobile(200), and the settlement is finished.

FIG. 12 depicts another embodiment of POS system of the invention, wherein a plurality of slave merchant mobiles(201), (202), . . . (20n) are connected to a master merchant mobile(200) and each of the slave merchant mobiles relays settlement between the master merchant mobile(200) and the purchaser mobile(100)s. This feature can be used for a mass of transactions from many purchaser mobile(100)s (ie. at marts or stadiums with many perchasers).

The structures of the master merchant mobile(200) and slave merchant mobiles(201), (202), . . . (20n) are basically identical to the one described in the FIG. 9, while the configuration enables a mass of transactions at the master merchant mobile(200) engaging a plurality of slave merchant mobiles(201), (202), . . . (20n).

In this POS system, each of purchaser mobile(100) is connected to transaction server(300) via mobile communication network. A plurality of slave merchant mobiles(201), (201), . . . (20n) are connected with the master merchant mobile(200) via both of short range communication channel and/or mobile communication network. The master merchant mobile(200) also connected to transaction server(300) via mobile communication network. The slave merchant mobiles(201), (201), . . . (20n) can be discriminated from the master merchant mobile(200) in that slaves are banned to access transaction server(300).

FIG. 13 shows process flow of the embodiment of present invention for a mass of transaction wherein, a master merchant mobile(200) commands a mass of transactions for many purchaser mobile(100)s engaging a plurality of slave merchant mobiles(201), (202), . . . (20n). The detailed process is as follows.
Step S300: merchant inputs billing amount for the goods or services offered to the purchaser to slave merchant mobile(20X), and slave merchant mobile(20X) generates transaction information including billing amount, ID (or internet protocol IP address) of slave merchant mobile(20X) and master merchant mobile(200), with additional data (ie. bank account for transaction etc.), then the slave merchant mobile(20X) transforms the transaction information into a barcode, and displays on the screen.
Step S310: the purchaser mobile(100) reads the barcode from the slave merchant mobile(20X) to extract the transaction information, and hashes the transaction information with purchaser's credit card information, then stores into transaction information storage(150).
Step S320: the purchaser mobile(100) reads the hashed information out from the transaction information storage(150) and sends to transaction server(300) to request settlement.
Step S330: on receiving the settlement request, the transaction server(300) accesses settlement and sends result information back to the purchaser mobile(100).
Step S340: the purchaser mobile(100) transmits settlement result information received from the transaction server(300) to the master merchant mobile(200).
Step S350: the master merchant mobile(200) transmits settlement result received from the purchaser mobile(100) to the corresponding slave merchant mobile(20X) and the settlement is finished.

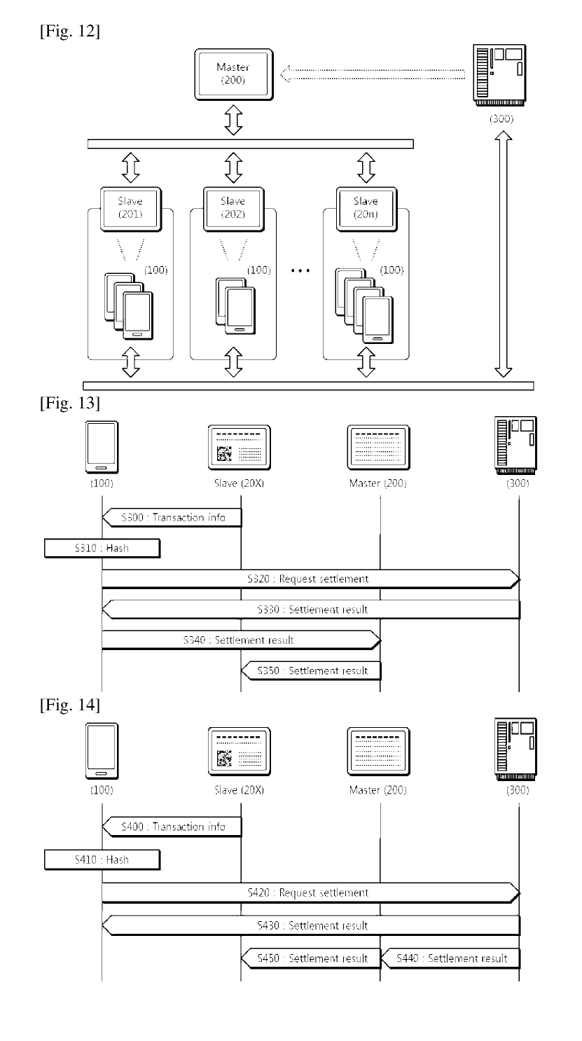

FIG. 14 shows process flow of another embodiment of present invention for a mass of transaction wherein, a master merchant mobile(200) commands a mass of transactions for many purchaser mobile(100)s engaging a plurality of slave merchant mobiles(201), (202), . . . (20n).

This settlement is different from the one described referring the FIG. 13 in that the transaction server sends settlement result information back to both of the purchaser mobile and the master merchant mobile(200). The detailed process is as follows.
Step S400: merchant inputs billing amount for the goods or services offered to the purchaser to slave merchant mobile(20X), and slave merchant mobile(20X) generates transaction information including billing amount, ID (or internet protocol IP address) of slave merchant mobile(20X) and master merchant mobile(200), with additional data (ie. bank account for transaction etc.), then the slave merchant mobile(20X) transforms the transaction information into a barcode, and displays on the screen.
Step S410: the purchaser mobile(100) reads the barcode from the slave merchant mobile(20X) to extract the transaction information, and hashes the transaction information with purchaser's credit card information, then stores into transaction information storage(150).
Step S420: the purchaser mobile(100) reads the hashed information out from the transaction information storage(150) and sends to transaction server(300) to request settlement.
Step S430, S440: on receiving the settlement request, the transaction server(300) accesses settlement and sends result information back to the both of purchaser mobile(100) and the master merchant mobile(200).
Step S450: the master merchant mobile(200) transmits settlement result received from the purchaser mobile(100) to the corresponding slave merchant mobile(20X) and the settlement is finished.

The above descriptions and illustrations of processes herein should not be considered to imply a fixed order for performing the process steps. Rather, the process steps may be performed in any order that is practicable, including simultaneous performance of at least some steps.

Although the present invention has been described in connection with specific example embodiments, it should be understood that various changes, substitutions, and alterations apparent to those skilled in the art can be made to the disclosed embodiments without departing from the spirit and scope of the invention as set forth in the appended claims.

### INDUSTRIAL APPLICABILITY

The mobile point of sale system for reverse settlement and method of present invention can be applicable in the field of POS system and concerned banking service using secured personal information in transaction.

1. A mobile point of sale system for reverse settlement wherein purchaser mobile settles transaction to use information offered from merchant mobile, the purchaser mobile comprising;
the first controller(110) to control over purchaser mobile(100);
the first mobile communication unit(120) to connect purchaser mobile(100) to transaction server(300) via mobile communication network;
creditcard information storage(130) to store creditcard information of purchaser for settlement;
the first short range communication unit(140) to establish communication between the purchaser mobile(100) and merchant mobile(200);
transaction information storage(150) to store transaction information from the merchant mobile(200);
barcode decoder(160) to read barcoded transaction information from the merchant mobile(200) screen by a camera (c).

2. The purchaser mobile of claim 1, wherein the information read by the reader is stored into the creditcard information storage(130) by the first controller(110), when purchaser mobile(100) uses mobile card reader device.

3. A mobile point of sale system for reverse settlement wherein purchaser mobile settles transaction to use information offered from merchant mobile, the merchant mobile comprising;
the second controller(210) to control over merchant mobile(200);
the second mobile communication unit(220) to connect merchant mobile(200) to mobile communication network;
display unit(230) to display barcoded transaction information of merchant mobile;
billing information calculation and store unit(240) to calculate and store billing amount, and to generate barcodes of transaction information;
the second short range communication unit(240) to establish short range communication with purchaser mobile(100) and other merchant mobiles(20X: slave merchant mobiles);
mobile data storage(250) to mobile IDs (or IP addresses) of other merchant mobiles(20X);

4. Operating method of mobile point of sale system for reverse settlement wherein purchaser mobile settles transaction to use information offered from merchant mobile comprising,
Step S100: merchant inputs billing amount for the goods or services offered to the purchaser to his/her mobile, and merchant mobile(200) generates transaction information including billing amount, ID (or internet protocol IP address), with additional data (ie. bank account for transaction etc.), then the merchant mobile(200) transforms the transaction information into a barcode, and displays on the screen,
Step S110: the purchaser mobile(100) reads the barcode from the merchant mobile(200) to extract the transaction information, and hashes the transaction information with purchaser's credit card information, then stores into transaction information storage(150),
Step S120: the purchaser mobile(100) reads the hashed information out from the transaction information storage(150) and sends to transaction server(300) to request settlement,
Step S130: On receiving the settlement request, the transaction server(300) accesses settlement and sends result information back to the purchaser mobile(100),
Step S140: the purchaser mobile(100) transmits settlement result information received from the transaction server(300) to the merchant mobile(200) and the settlement is finished.

5. Operating method of mobile point of sale system for reverse settlement wherein purchaser mobile settles transaction to use information offered from merchant mobile comprising,
Step S200: merchant inputs billing amount for the goods or services offered to the purchaser to his/her mobile, and merchant mobile(200) generates transaction information including billing amount, ID (or internet protocol IP address), with additional data (ie. bank account for transaction etc.), then the merchant mobile(200) transforms the transaction information into a barcode, and displays on the screen.
Step S210: the purchaser mobile(100) reads the barcode from the merchant mobile(200) to extract the transaction information, and hashes the transaction information with purchaser's credit card information, then stores into transaction information storage(150).
Step S220: the purchaser mobile(100) reads the hashed information out from the transaction information storage(150) and sends to transaction server(300) to request settlement.
Step S230, S240: On receiving the settlement request, the transaction server(300) accesses settlement and sends result information back to the both of purchaser mobile(100) and merchant mobile(200), and the settlement is finished.

6. Operating method of mobile point of sale system for reverse settlement wherein purchaser mobile settles transaction to use information offered from a slave merchant mobile connected to a master merchant mobile, comprising,
Step S300: merchant inputs billing amount for the goods or services offered to the purchaser to slave merchant mobile(20X), and slave merchant mobile(20X) generates transaction information including billing amount, ID (or internet protocol IP address) of slave merchant mobile(20X) and master merchant mobile(200), with additional data (ie. bank account for transaction etc.), then the slave merchant mobile(20X) transforms the transaction information into a barcode, and displays on the screen.
Step S310: the purchaser mobile(100) reads the barcode from the slave merchant mobile(20X) to extract the transaction information, and hashes the transaction information with purchaser's credit card information, then stores into transaction information storage(150).
Step S320: the purchaser mobile(100) reads the hashed information out from the transaction information storage(150) and sends to transaction server(300) to request settlement.
Step S330: on receiving the settlement request, the transaction server(300) accesses settlement and sends result information back to the purchaser mobile(100).
Step S340: the purchaser mobile(100) transmits settlement result information received from the transaction server(300) to the master merchant mobile(200).
Step S350: the master merchant mobile(200) transmits settlement result received from the purchaser mobile(100) to the corresponding slave merchant mobile(20X) and the settlement is finished.

7. Operating method of mobile point of sale system for reverse settlement wherein purchaser mobile settles transaction to use information offered from a slave merchant mobile connected to a master merchant mobile, comprising,
Step S400: merchant inputs billing amount for the goods or services offered to the purchaser to slave merchant mobile(20X), and slave merchant mobile(20X) generates transaction information including billing amount, ID (or internet protocol IP address) of slave merchant mobile(20X) and master merchant mobile(200), with additional data (ie. bank account for transaction etc.), then the slave merchant mobile(20X) transforms the transaction information into a barcode, and displays on the screen.
Step S410: the purchaser mobile(100) reads the barcode from the slave merchant mobile(20X) to extract the transaction information, and hashes the transaction information with purchaser's credit card information, then stores into transaction information storage(150).
Step S420: the purchaser mobile(100) reads the hashed information out from the transaction information storage(150) and sends to transaction server(300) to request settlement.
Step S430, S440: on receiving the settlement request, the transaction server(300) accesses settlement and sends result information back to the both of purchaser mobile(100) and the master merchant mobile(200).
Step S450: the master merchant mobile(200) transmits settlement result received from the purchaser mobile(100) to the corresponding slave merchant mobile(20X) and the settlement is finished.
